(19) United States
(12) Patent Application Publication
(10) Pub. No.: US 2007/0076005 A1
(43) Pub. Date: Apr. 5, 2007

(54) Robust hot plug detection for analog displays using EDID

(76) Inventors: Lawrence E. Knepper, Austin, TX (US); Randall E. Juenger, Belton, TX (US); Thomas P. Lanzoni, Cedar Park, TX (US)

Correspondence Address: HAMILTON & TERRILE, LLP, P.O. BOX 203518, AUSTIN, TX, 78720, US

(21) Appl. No.: 11/239,751

(22) Filed: Sep. 30, 2005

(51) Int. Cl. G06F 13/14

(52) U.S. Cl. 345/520

(57) ABSTRACT

The present invention provides a method and apparatus for automatically detecting whether an external monitor is connected to a video port of an information handling system. In various embodiments of the invention, detection of the display is accomplished by periodic polling to detect the presence of an Extended Display Identification Data (EDID) signal as an indication of whether a display has been plugged in or removed. In embodiments of the invention, hardware polling is implemented to provide the interrupt-driven mechanism, thereby relieving software of the performance degradation associated with polling the video port at very short time intervals.

### BACKGROUND OF THE INVENTION

1. Field of the Invention

The present invention relates in general to the field of information handling systems and, more specifically, to detection of displays used in connection with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

Many portable information handling systems, such as laptop computers, are capable of displaying information on multiple displays. Typically, one of the displays is integrated into the laptop computer and another display can be connected to an auxiliary video port on the laptop's video subsystem. It is important for an information handling system (particularly a laptop) to have the capability to automatically determine whether a display is connected to, or disconnected from, an auxiliary display port. Detecting that a display has been connected to the video port is important to ensure that the port is enabled to provide video data to the display. It is important to detect that the display has been disconnected in order to reduce the power level provided to the port to conserve battery power.

One prior art method for detecting a display involves monitoring the output voltage of an analog-to-digital converter (DAC) connected to the port. In this method, the output voltage of the DAC doubles if one of the 75 ohm terminators is absent from the port. Another method relies on a “presence detect” that uses reserved pins on the analog port to detect the presence of a monitor. These reserved pins, however, vary from one manufacturer to another.

Prior art methods for detecting monitors attached to video graphics adapter (VGA) ports have been inconvenient or unreliable for the reasons discussed above. It is apparent, therefore, that there is a need for a robust and reliable method for determining whether a display device (projector or monitor, etc.) is attached or removed from an information handling system's analog VGA display port.

### SUMMARY OF THE INVENTION

The present invention provides a method and apparatus for automatically detecting whether an external monitor is connected to a video port of an information handling system. In various embodiments of the invention, detection of the display is accomplished by periodic polling to detect the presence of an Extended Display Identification Data (EDID) signal as an indication of whether a display has been plugged in or removed. In some embodiments of the invention, hardware polling is implemented to provide the interrupt-driven mechanism, thereby relieving software of the performance degradation associated with polling the video port at very short time intervals.

The present invention can be implemented on a simple circuit that can be added to any graphics processor or implemented as a small PLA on the graphics board.

Those of skill in the art will understand that many such embodiments and variations of the invention are possible, including but not limited to those described hereinbelow in the detailed description of the invention.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 is a block diagram of the functional modules for detecting a display using automatic detection of EDID in accordance with the present invention.

FIG. 3 is a state diagram of the processing steps for detecting a display using automatic detection of EDID in accordance with the present invention.

### DETAILED DESCRIPTION

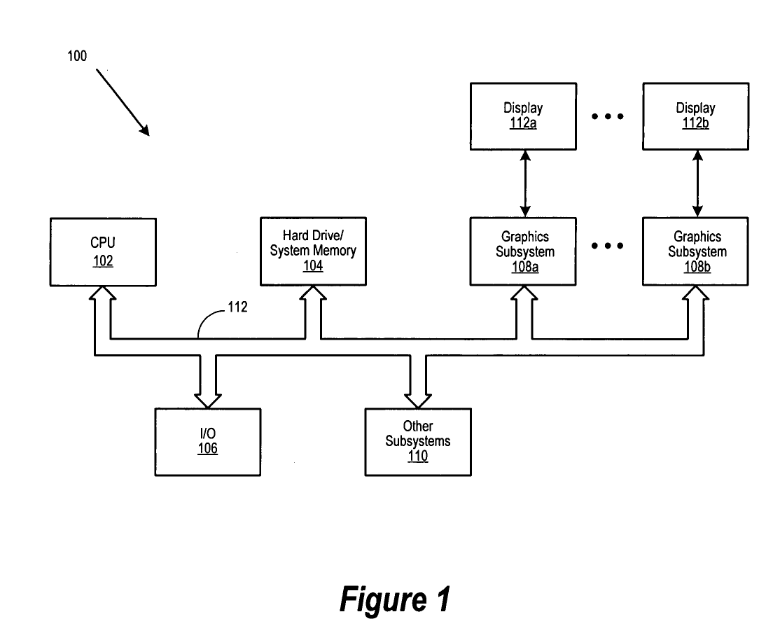

FIG. 1 is a generalized illustration of an information handling system 100 that can be used to implement the method and apparatus of the present invention. The information handling system includes a processor 102, a hard disk drive and system memory 104, an input/output (I/O) interface 106, graphics subsystem(s) 108a, 108b and various other subsystems 110 understood by those of skill in the art. The various system components of the information handling system 100 are interconnected via one or more buses 112. In various embodiments of the invention the bus 112 can be implemented using protocols and standards established for PCI-Express, as set forth in the PCI-Express Base Specification Revision 1.0, published on Jul. 22, 2002.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display.

As discussed above, many portable information handling systems, such as laptop computers, are capable of displaying information on multiple displays. One of the displays is typically integrated into the laptop computer and another display can be connected to an auxiliary video port on the laptop's video subsystem. The graphics subsystems 108a and 108b shown in FIG. 1 are operable to control the operation of displays 112a and 112b, respectively. One of the displays, e.g., 112a may be integrated in a laptop computer, while the other display, e.g., 112b is operably connected to the graphics subsystem 108b by an auxiliary connector such as an analog VGA port. As will be understood by those of skill in the art, most current displays are capable of exchanging Extended Display Identification Data (EDID) in accordance with standards promulgated by the Video Electronic Standards Association (VESA). The EDID is based on a VESA standard data format containing basic information about a display device and its capabilities including, but not limited to, vendor information, maximum image size, color characteristics, factory pre-set timings, frequency range limits, and character strings for the monitor name and serial number.

The information exchanged between the information handling system and the displays 112a or 112b is generally transmitted over a data channel referred to as a Display Data Channel (DDC). As will be discussed in greater detail hereinbelow, the present invention provides a method and apparatus for automatically determining whether an EDID is present and, therefore, whether a display is connected to an analog VGA port.

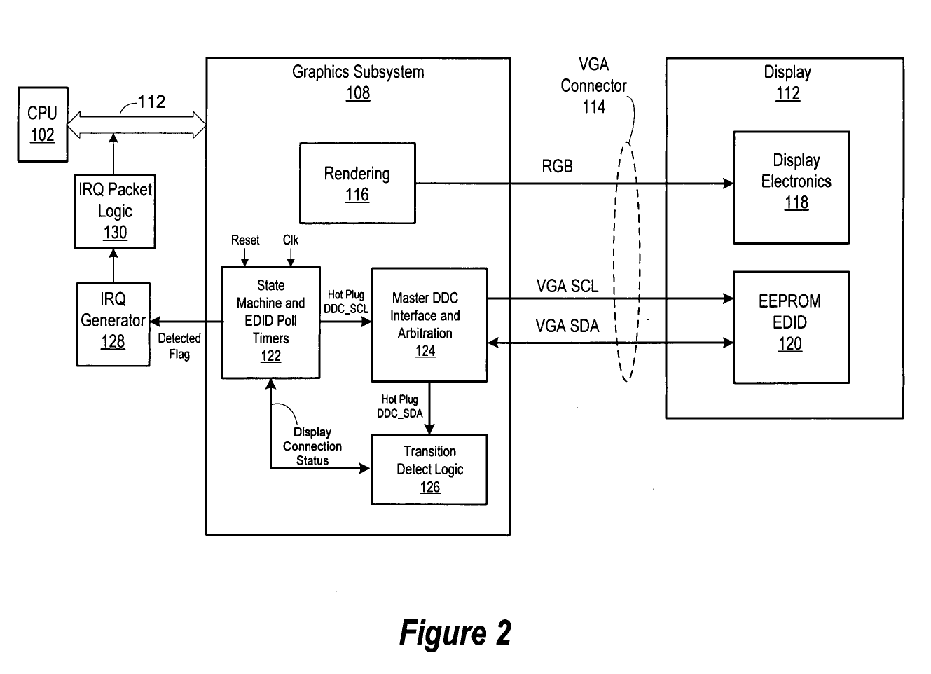

FIG. 2 is an illustration of circuit modules in the graphics subsystems 108a, 108b and the displays 112a, 112b shown in FIG. 1. For discussion purposes the relevant system components will be discussed in association with a generalized graphics subsystem 108 and a display 112 having the detection logic and control circuitry operable to implement the present invention. Referring again to FIG. 2, the display 112 is connected to the graphics subsystem 108 by an appropriate VGA connector 114. The graphics subsystem 108 comprises a rendering module 116 that is operable to generate red, green and blue (RGB) signals that are provided to the display electronics 118 to generate a video image on the display 112. A state machine and EDID poll timers module 122 is operable to generate a “hot plug” DDC serial clock signal (DDC SCL). The master DDC interface and arbitration module 124 is operable to receive the DDC SCL signal and to generate a VGA serial clock signal (VGA SCL). The display 112 comprises an EEPROM EDID 120 that is operable to receive the VGA serial clock signal (VGA SCL) from the master DDC Interface and Arbitration module 124 and to generate a VGA data signal (VGA SDA) in response thereto. The master DDC interface and arbitration module is operable to receive the VGA SDA signal from the EEPROM 120 and to generate a “hot plug” DDC SDA signal therefrom. The DDC SDA signal is processed by the transition detect logic 126 to detect whether the display 112 is attached to the VGA port 114 and provides a display connection status signal to the state machine and EDID poll timers module 122. The state machine and EDID poll timers module processes the signal received from the transition logic module 126 in accordance with a state machine transition sequence described herein below. Upon detection of a change in the connection status of the port 114, i.e., the connection or disconnection of a display, the state machine and EDID poll timers module 122 generates a “detected flag” to indicate that a change has been detected with regard to the connection status of the VGA port 114. This flag is used by the IRQ generator 128 to generate an appropriate interrupt flag that is provided to the IRQ packet logic module 130 to generate a packet on the bus 112.

As discussed hereinabove, the IRQ packet logic 130 and the bus 112 can be implemented using the PCI-Express protocols. Communication of data signals between the display 112 and the data processing circuitry in the graphics subsystem 108 can be implemented using a two-wire serial bus, such as the Inter-Integrated Circuit Bus (1²C Bus) as described in the “I²C-Bus Specification,” Version 2.1, published by U.S. Philips Corporation, January 2000.

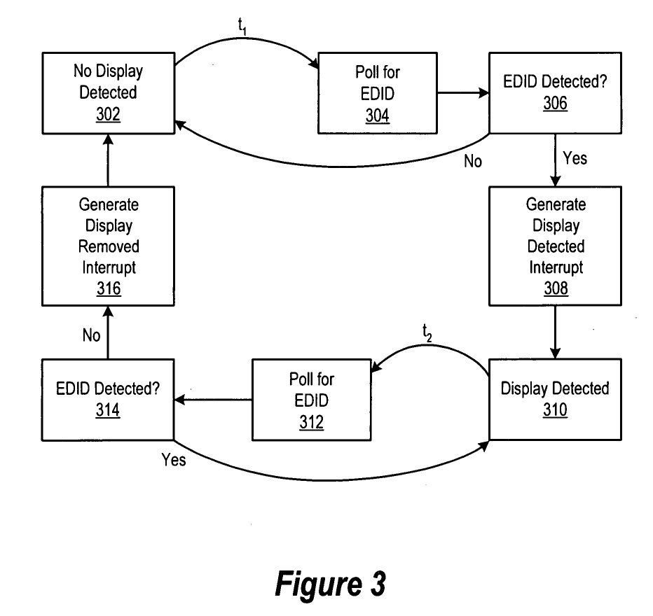

FIG. 3 is a state diagram of the steps implemented by the state machine and EDID poll timers module 122 of the present invention. The initial state 302 is the default state in which no display has been detected. At predetermined time intervals, ti, the system transitions to state 304 where a poll is initiated in an attempt to detect the presence of EDID data. In state 306, a test is conducted to determine whether EDID was detected. If the result of the test conducted in state 306 indicates that no EDID was detected, the system transitions back to state 302. If, however, the test conducted in state 306 indicates that EDID was detected, the system transitions to state 308 where an interrupt is generated, indicating that the display was detected. The system then transitions to state 310 where the appropriate VGA port is maintained in an active state. At a predetermined time interval t₂, the system transitions to state 312 where the VGA port is polled for EDID data. In state 314, a test is conducted to determine whether EDID data is still present. If the results of the test conducted in state 314 indicates that EDID data is still being detected, the system transitions to state 310 and the VGA port is maintained in an active state. If, however, the test conducted in state 314 indicates that no EDID data is detected, the system transitions to state 316 and an interrupt is generated, indicating that the display has been removed. The system then transitions to state 302 where the VGA port is maintained in an inactive state and the polling for EDID data in steps 304 and 306 is repeated as discussed hereinabove.

In various embodiments of the invention, the predetermined time periods t₁ and t₂ are 100 milliseconds. However, these time intervals can be set at other predetermined intervals while maintaining the advantages of the present invention, as will be appreciated by those of skill in the art.

Although the present invention has been described in detail, it should be understood that various changes, substitutions and alterations can be made hereto without departing from the spirit and scope of the invention as defined by the appended claims.

What is claimed is:

1. A system for detecting a display attached to an information handling system, comprising:
a graphics system operable to generate a hot plug polling signal at predetermined timing intervals and to receive a hot plug data signal response thereto; and
a display operable to receive said hot plug polling signal and generate said hot plug data signal in response thereto;
wherein said graphics system further comprises data processing logic operable to detect said hot plug data signal and to generate an interrupt signal indicating the connection status of said display.

2. The system of claim 1, wherein said display is operably coupled to said graphics subsystem by a video graphics adapter port.

3. The system of claim 2, wherein said hot plug data signal comprises extended display identification data.

4. The system of claim 3, wherein said hot plug polling signal comprises a serial clock signal.

5. The system of claim 4, wherein said data processing logic comprises a state machine operable to generate a display status flag for use by an interrupt generator

6. A method for detecting a display connected to an information handling system, comprising:
using a graphics system to generate a hot plug polling signal at predetermined timing intervals and to receive a hot plug data signal response thereto; and
using a display to receive said hot plug polling signal and to generate said hot plug data signal in response thereto;
generating an interrupt signal indicating the connection status of said display.

7. The method of claim 6, wherein said display is operably coupled to said graphics subsystem by a video graphics adapter port.

8. The method of claim 7, wherein said hot plug data signal comprises extended display identification data.

9. The method of claim 8, wherein said hot plug polling signal comprises a serial clock signal.

10. The method of claim 9, wherein said data processing logic comprises a state machine operable to generate a display status flag for use by an interrupt generator.

11. A system for detecting a display attached to an information handling system, comprising:
a first a graphics system;
a first display operably coupled to said first graphics system;
a second graphics system operable to generate a hot plug polling signal at predetermined timing intervals and to receive a hot plug data signal response thereto; and
a second display operably coupled to said second graphics system, said second display operable to receive said hot plug polling signal and generate said hot plug data signal in response thereto;
wherein said second graphics system further comprises data processing logic operable to detect said hot plug data signal and to generate an interrupt signal indicating the connection status of said display.

12. The system of claim 1, wherein said second display is operably coupled to said graphics subsystem by a video graphics adapter port.

13. The system of claim 2, wherein said hot plug data signal comprises extended display identification data.

14. The system of claim 3, wherein said hot plug polling signal comprises a serial clock signal.

15. The system of claim 4, wherein said data processing logic comprises a state machine operable to generate a display status flag for use by an interrupt generator

16. A method for detecting a display connected to an information handling system, comprising:
operably coupling a first display to a first graphics system;
operably coupling a second display to a second graphics system;
using said second graphics system to generate a hot plug polling signal at predetermined timing intervals and to receive a hot plug data signal response thereto;
using said second display to receive said hot plug polling signal and to generate said hot plug data signal in response thereto; and
generating an interrupt signal indicating the connection status of said second display.

17. The method of claim 6, wherein said second display is operably coupled to second said graphics subsystem by a video graphics adapter port.

18. The method of claim 7, wherein said hot plug data signal comprises extended display identification data.

19. The method of claim 8, wherein said hot plug polling signal comprises a serial clock signal.

20. The method of claim 9, wherein said data processing logic comprises a state machine operable to generate a display status flag for use by an interrupt generator.
